(19) United States
(12) Patent Application Publication
(10) Pub. No.: US 2026/0037794 A1
(43) Pub. Date: Feb. 5, 2026

(54) PIXELATED ENCODER MACHINE LEARNING MODEL FOR MATCHING DISPARATE DATA

(71) Applicant: Intuit Inc., Mountain View, CA (US)

(72) Inventor: Ranadeep BHUYAN, Melbourne (AU)

(73) Assignee: Intuit Inc., Mountain View, CA (US)

(21) Appl. No.: 18/789,658

(22) Filed: Jul. 30, 2024

(51) Int. Cl. G06N 3/08

(52) U.S. Cl. CPC G06N 3/08

(57) ABSTRACT

A method including using a set of machine learning models to identify a source dataset that matches a target dataset. The source and target datasets are received as a source and target image data structures. A set of multimodal convolutional layers of encoding networks are applied to the source and target image data structures to generate classes of data. Missing pixels that are missing in at least one of the source and target image data structures are identified. Supplemental pixels corresponding to the missing pixels are generated from text present in at least one of the source and target datasets. At least one of the source and target image data structures are augmented with the supplemental pixels to generate at least one enhanced image. The method also includes retraining, using an augmented data structure including the at least one enhanced image, the encoding and decoding networks.

### BACKGROUND

A difficult problem in computer science is identifying related data in disparate datasets. For example, a source dataset (e.g., a first dataset in one data repository) may be related to a target dataset (e.g., a second dataset in another data repository), but the datasets may have many differences. Because many datasets may exist in the second data repository, and because differences may exist between the source dataset and the target dataset, identifying the target dataset as being related to the source dataset may be a difficult technical problem.

### SUMMARY

One or more embodiments provide for a method. The method includes applying a set of machine learning models to a first group of datasets and a second group of datasets to identify a source dataset, in the first group of datasets, that matches a target dataset, in the second group of datasets. The method also includes receiving the source dataset as a source image data structure and receiving the target dataset as a target image data structure. The method also includes applying a set of multimodal convolutional layers of encoding networks to the source image data structure and the target image data structure to generate classes of data present in at least one of the source image data structure and the target image data structure. The method also includes identifying, using the source image data structure and the target image data structure, missing pixels that are missing in at least one of the source image data structure and the target image data structure. The method also includes generating, from text present in at least one of the source dataset and the target dataset, supplemental pixels corresponding to the missing pixels. The method also includes augmenting at least one of the source image data structure and the target image data structure with the supplemental pixels to generate at least one enhanced image. The method also includes retraining, using an augmented data structure including the at least one enhanced image, the set of multimodal convolutional layers of the encoding networks and a set of decoding networks to generate a retrained model.

One or more embodiments provide for another method. The method includes applying a set of machine learning models to a first group of datasets and a second group of datasets to identify a source dataset, in the first group of datasets, that matches a target dataset, in the second group of datasets. The method also includes receiving the source dataset as a source image data structure and receiving the target dataset as a target image data structure. The method also includes applying a set of multimodal convolutional layers of encoding networks to the source image data structure and the target image data structure to generate a vector including an encoded representation of the target image data structure and the source image data structure, and also classes of data present in at least one of the source image data structure and the target image data structure. The method also includes identifying, using the source image data structure, the target image data structure, and the classes of data, missing pixels that are missing in at least one of the source image data structure and the target image data structure. The method also includes generating, from text present in at least one of the source dataset and the target dataset, supplemental pixels corresponding to the missing pixels. The method also includes applying the set of multimodal convolutional layers to the supplemental pixels to generate a supplemental vector. The method also includes augmenting the vector with the supplemental vector to generate an enhanced vector. The method also includes applying a set of decoding networks to the enhanced vector to generate a reconstructed target image data structure. The method also includes comparing the target image data structure or the source image data structure to the reconstructed target image data structure to generate a difference. The method also includes storing, in a non-transitory computer readable storage medium and responsive to the difference satisfying a threshold value, the target dataset as being related to the source dataset.

One or more embodiments also provide for a system. The system includes a computer processor and a data repository in communication with the computer processor. The data repository stores a first group of datasets including a source dataset including a source image data structure. The data repository also stores a second group of datasets including a target dataset including a target image data structure. The data repository also stores text present in at least one of the source dataset and the target dataset. The data repository also stores classes of data present in at least one of the source image data structure and the target image data structure. The data repository also stores missing pixels that are missing in at least one of the source image data structure and the target image data structure. The data repository also stores supplemental pixels corresponding to the missing pixels. The data repository also stores at least one enhanced image. The data repository also stores an augmented data structure including a combination of the at least one enhanced image, the classes of data, and the text. The system also includes a set of machine learning models trained, when executed by the computer processor, to compare the first group of datasets and the second group of datasets to identify the source dataset and the target dataset. The system also includes a set of multimodal convolutional layers of encoding networks trained, when executed by the computer processor, to generate the classes of data present in at least one of the source image data structure and the target image data structure. The system also includes a set of decoding networks programmed, when executed by the computer processor, to identify, using the source image data structure and the target image data structure, the missing pixels. The set of decoding networks is further programmed to generate, from the text, the supplemental pixels. The set of decoding networks is further programmed to augment at least one of the source image data structure and the target image data structure with the supplemental pixels to generate the at least one enhanced image. The system also includes a training controller programmed, when executed by the computer processor and using the set of augmented data structures, to generate a retrained model by retraining the set of multimodal convolutional layers of the encoding networks and the set of decoding networks.

Other aspects of one or more embodiments will be apparent from the following description and the appended claims.

### BRIEF DESCRIPTION OF DRAWINGS

FIG. 1A and FIG. 1B show a computing system, in accordance with one or more embodiments.

FIG. 2 and FIG. 3 show flowcharts of methods for training and using a pixelated encoder machine learning model for matching disparate data, in accordance with one or more embodiments.

FIG. 4 shows an example of using a pixelated encoder machine learning model for matching disparate data as part of an automated transaction categorization system, in accordance with one or more embodiments.

FIG. 5A and FIG. 5B show a computing system and network environment, in accordance with one or more embodiments.

Like elements in the various figures are denoted by like reference numerals for consistency.

### DETAILED DESCRIPTION

One or more embodiments are directed to identify related datasets among disparate data sources. Namely, a new model type is trained to be able to identify a specific target dataset, among many possible target datasets in a target data group, that is related to a source dataset even though the source and target datasets are disparate (e.g., show different types or amounts of data, or are stored in different data formats). Thus, one or more embodiments address the technical problem of matching related data among disparate datasets by training a new machine learning model.

A more specific example is given to highlight the technical problem. A business sends an invoice to a customer via email. The customer pays the invoice via an online pay service to an account that the business maintains with the online pay service. The business then transfers money of a different dollar amount (from multiple payments to the online service) from the online pay service to the bank. When the business executes accounting software to reconcile all invoices and payments, the bank statement never shows a payment against the invoice. Furthermore, the pay service statement shows a payment against the invoice, but the amount is different than the amount transferred to the bank. Further, the pay service statement stores data differently than the bank statement. As a result, the accounting software treats the bank statement transaction (i.e., a source dataset) and the pay service statement transaction (i.e., a target dataset) as being independent. However, neither is reconciled by the accounting software, as the bank statement cannot be reconciled with the pay service statement due to the different dollar amounts and the different data types used by the bank and the pay service.

The issue described above arises from the technical problem of the computing system being unable to match the disparate target and source datasets with a desired degree of accuracy. One or more embodiments address the technical problem via a technical solution of training an improved pixelated encoder machine learning model to match the disparate datasets.

Initially, a set of matching machine learning models are used to match a set of candidate target datasets to a source dataset. However, the matching machine learning models are insufficiently accurate in terms of correctly identifying that a given target dataset is actually related to the source dataset. The term “insufficiently accurate” is measured by comparing the observed accuracy of the matching machine learning models against a predetermined acceptable standard of accuracy.

The source and target datasets are then received, or converted, into an image data structure including a number of pixels. A set of multimodal convolutional layers of one or more encoding networks are then applied to the source and target image data structures. The output of the multimodal convolutional layers of the encoding networks is a set of classes (e.g., unsupervised classes) that are contained in the image. The classes may be categories of data contained within the images.

Next, missing pixels that are missing in at least one of the images are identified. For example, because the source and target datasets are disparate, the images of the datasets will contain differences expressed as differences in the pixels among the images. Pixels missing in the source data image structure, but not in the target image data structure (or vice versa), are thereby identifiable.

Supplemental pixels that are in one of the datasets, but not the other, are then generated. The image data structure (either source or target) that is missing pixels is augmented by adding an embedded version of the supplemental pixels to the embedded version of the image data structure having missing pixels. The term “embedded” means that the data in question has been converted into a data structure format suitable for input to a machine learning model (e.g., a vector, as defined below). Also added to the embedded data structure is an embedded version of the identified classes of data and any text in the image. The result is an augmented data structure which includes an embedded version of a combination of the at least one enhanced image, the classes of data, and the text.

Finally, both the set of multimodal convolutional layers of the encoding networks as well as the decoding networks are retrained using the augmented data structure. The combination of the set of multimodal convolutional layers of the encoding networks and the decoding networks may be referred to as ‘encoding-decoding networks.’ Retraining the encoding-decoding networks creates a new model referred to as a retrained model.

The retrained model may then be used to match disparate data types using a similar procedure, but rather than retraining the encoding-decoding networks, an inference may be drawn between disparate datasets, converted into images, to identify whether the disparate datasets are related to each other. The retrained encoding-decoding networks operate at least partially on image data, and therefore may be referred to as a pixelated encoder machine learning model.

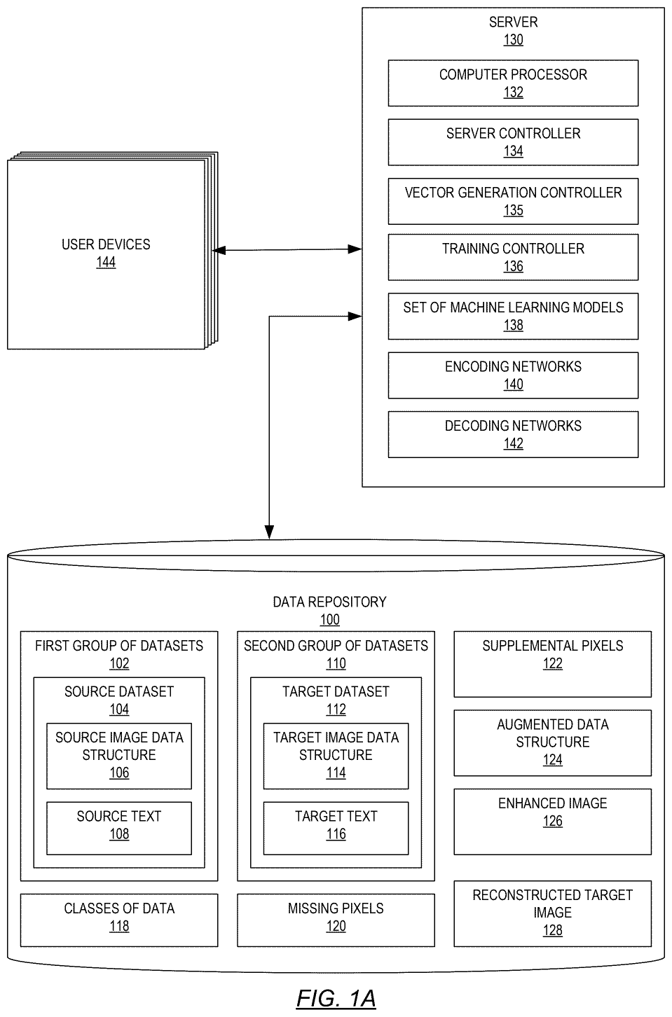

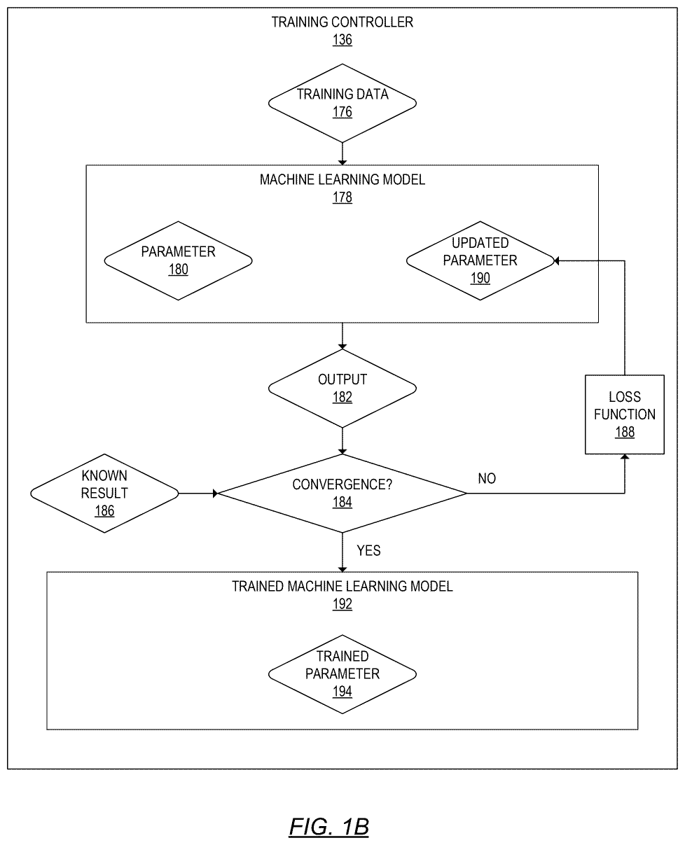

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores a first group of datasets (102). As used herein a “dataset” is logically associated data that, taken as a whole, forms information of interest. Thus, for example, a dataset may be a number, word, phrase, sentence, document, etc. Datasets may be arranged in groups. For example, if a dataset is a row entry in a spreadsheet, then a group of datasets may be two or more of the rows in the spreadsheet. However, in another example, if a dataset is data contained in a cell of the spreadsheet, then a group of datasets may be two or more of the cells in the spreadsheet. In one or more embodiments, the first group of datasets (102) is referred to as a “first group” for identification purposes, without implying a particular order or nature of the group of data.

Thus, for example, the first group of datasets (102) contains a source dataset (104). The source dataset (104) is a dataset that is to be compared to another dataset (e.g., the target dataset (112)) in order to determine whether the two datasets are related.

The source dataset (104) may include, or be converted into, a source image data structure (106). The source image data structure (106) is an electronic image that represents some or all of the information represented in the source dataset (104). The electronic image is an organized collection of pixels that form the image when displayed on a display screen. The source image data structure (106) also may be represented in a computer readable format, such as a vector data structure (defined below with respect to FIG. 1B), which embeds the pixels and the arrangement of the pixels into a computer readable data structure.

The source dataset (104) also may include source text (108). The source text (108) is alphanumeric text or special characters (e.g., “*,” “!,” “@,” “\hat{ },” etc.) that represent some or all of the information present in the source dataset (104). In an embodiment, the source dataset (104) may contain a combination of the source image data structure (106) and the source text (108).

The data repository (100) also may store the second group of datasets (110). The datasets in the second group of datasets (110) are datasets in the meaning defined above with respect to the first group of datasets (102). However, the second group of datasets (110) may be a disparate data type, a disparate arrangement of data, or disparate information, relative to the first group of datasets (102).

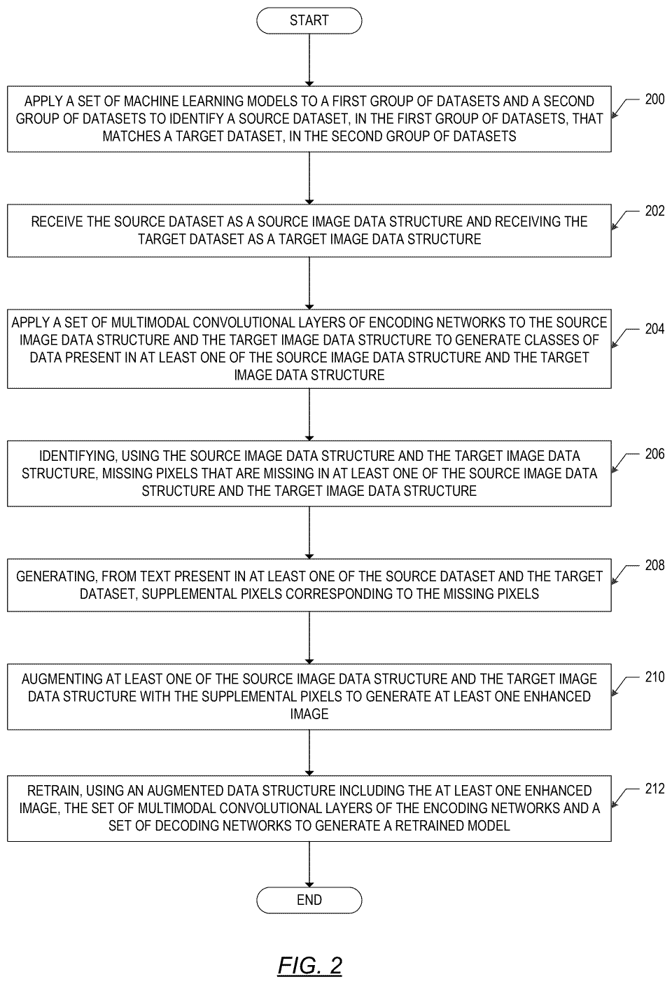

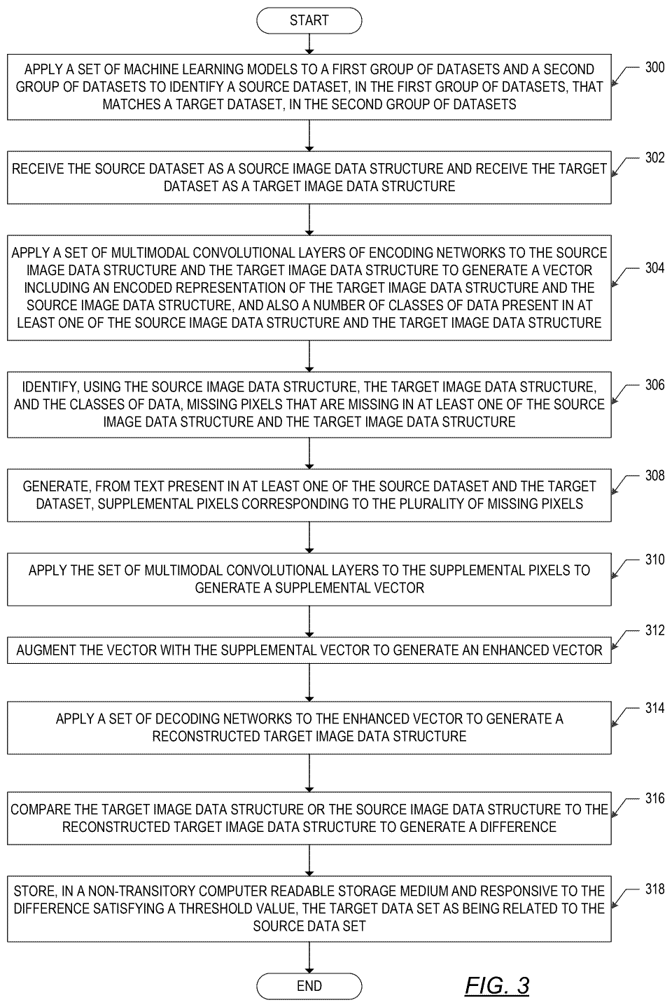

The second group of datasets (110) includes a target dataset (112). The target dataset (112) is a dataset, identified in the second group of datasets (110) as possibly being related to the source dataset (104) in the first group of datasets (102). The target dataset (112) is compared to the source dataset (104), as described with respect to FIG. 2 and FIG. 3, to determine whether the source dataset (104) is related to the target dataset (112), despite the differences between the two datasets.

The target dataset (112) may include a target image data structure (114). The target image data structure (114) is similar in nature to the source image data structure (106); however, the target image data structure (114) is an image, composed of pixels, that represents some or all of the data in the target dataset (112).

The target dataset (112) also may include target text (116). The target text (116), like the source text (108), is alphanumeric text or special characters that represent some or all of the data in the target dataset (112). In an embodiment, the target dataset (112) may contain a combination of the target image data structure (114) and the target text (116).

As shown in FIG. 1A, the first group of datasets (102) and the second group of datasets (110) are contained in the same data repository (100). However, in an embodiment, one or both of the first group of datasets (102) and the second group of datasets (110) are stored in different data repositories remote from the data repository (100). “Remote” means that the data repository in question is not part of the system shown in FIG. 1A, in terms of physical location, logical division, ownership, or a combination thereof. The different data repositories may be different types of data repositories and may store the respective groups of datasets differently in different types of data structures or may contain information related to different data classes.

The data repository (100) also may store one or more classes of data (118). The classes of data (118) are types of information contained in one or both of the source dataset (104) or the target dataset (112). For example, if the source dataset (104) is a bank statement, then the classes of data (118) may be “account number,” “dollar amount,” “transaction identifier,” etc. However, if the source dataset (104) is astronomical data, then the classes of data may be, for example, “star identification,” “star type,” “stellar mass,” “stellar composition,” etc.

The data repository (100) also may store a number of missing pixels (120). The missing pixels (120) are pixels that are present in either the source dataset (104) or the target dataset (112), but not in the other of the source dataset (104) or the target dataset (112). Thus, for example, the missing pixels (120) may be pixels present in the source image data structure (106) but not in the target image data structure (114), or vice versa. In an embodiment, the missing pixels (120), when taken together as a whole, may represent an entry of information or a class of information (and the entry for the class) that is present in the source image data structure (106) but not in the target image data structure (114) (or vice versa).

The data repository (100) also may store a number of supplemental pixels (122). The supplemental pixels (122) are pixels that are generated according to the method of FIG. 2 or FIG. 3, as described below. In particular, the supplemental pixels (122) are pixels generated to represent the missing pixels (120) that are missing in one of the two datasets (i.e., the source image data structure (106) of the source dataset (104) or the target image data structure (114) of the target dataset (112)).

The data repository (100) also may store an augmented data structure (124) or multiple augmented data structures. The augmented data structure (124) is a data structure that contains a number of different types of information, as generated according to the method of FIG. 2. In particular, the augmented data structure (124) contains a combination of at least one enhanced image (126) (defined below), the classes of data (118), and text (i.e., the source text (108), the target text (116), or both the source text (108) and the target text (116)). The augmented data structure (124) takes the form of a vector data structure. A vector data structure is defined with respect to FIG. 1B, below. Generation and use of the augmented data structure (124) is described with respect to FIG. 2 and FIG. 3.

The data repository (100) also may store an enhanced image (126), or multiple enhanced images. The enhanced image (126) is an image that is constructed from the image data structure that is missing pixels (the missing pixels (120)), but to which the supplemental pixels (122) are added. Generation and use of the enhanced image (126) is described with respect to FIG. 2 or FIG. 3.

The data repository (100) also may store a reconstructed target image (128). The reconstructed target image (128) is an image that is constructed from an augmented vector data structure during an inference phase of use of the decoding networks (142). The reconstructed target image (128) is compared to the source image data structure (106) or the target image data structure (114), whichever data structure that has the missing pixels (120). Thus, the reconstructed target image (128) is used with respect to determine whether the target image data structure (114) is related to the source image data structure (106), as described with respect to FIG. 3.

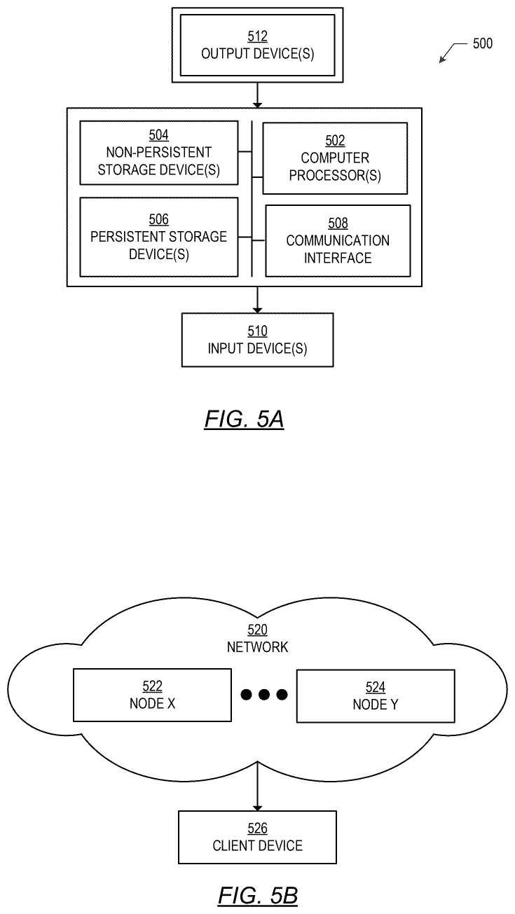

The system shown in FIG. 1A may include other components. For example, the system shown in FIG. 1A also may include a server (130). The server (130) is one or more computer processors, data repositories, communication devices, and supporting hardware and software. The server (130) may be in a distributed computing environment. The server (130) is configured to execute one or more applications, such as the set of machine learning models (138), the encoding networks (140), and the decoding networks (142). An example of a computer system and network that may form the server (130) is shown and described with respect to FIG. 5A and FIG. 5B.

The server (130) includes a computer processor (132). The computer processor (132) is one or more hardware or virtual processors which may execute computer readable program code that defines one or more applications, such as the server controller (134), the training controller (136), the set of machine learning models (138), the encoding networks (140), and the decoding networks (142). An example of the computer processor (132) is described with respect to the computer processor(s) (502) of FIG. 5A.

The server (130) also may include a server controller (134). The server controller (134) is software or application specific hardware which, when executed by the computer processor (132), controls and coordinates operation of the software or application specific hardware described herein. Thus, the server controller (134) may control and coordinate execution of the training controller (136), the set of machine learning models (138), the encoding networks (140), and the decoding networks (142).

The server (130) may include a vector generation controller (135) that may be part of the server controller (134). The vector generation controller (135) may be an embedding machine learning model that is trained to convert image data, text, or both into a vector data structure composed of features and values. An example of the vector generation controller (135) may be an ADA-002 machine learning model or a word2vec machine learning model. However, many different embedding models may be used. Use of the vector generation controller is shown and described with respect to FIG. 2 and FIG. 3.

The server (130) also may include a training controller (136). The training controller (136) is software or application specific hardware which, when executed by the computer processor (132), trains one or more machine learning models (e.g., the set of machine learning models (138), the encoding networks (140), and the decoding networks (142)). The training controller (136) is described in more detail with respect to FIG. 1B.

The server (130) also includes a set of machine learning models (138). The set of machine learning models (138) may be a set of ensembled multimodal linear models. The set of machine learning models (138) may be classification or matching machine learning models trained to compare datasets in the first group of datasets (102) to disparate datasets in the second group of datasets (110) and determine whether any of the datasets in the two groups match. If the groups of datasets include images, then the set of machine learning models (138) may include one or more convolution neural networks (CNNs) that compare images (e.g., the source image data structure (106) and the target image data structure (114)). If the datasets include text, then the set of machine learning models (138) may include one or more logistic regression machine learning models or large language models. The set of machine learning models also include a set of text-based regression machine learning models.

The inputs to each machine learning model in the set of machine learning models (138) are the first group of datasets (102) and the second group of datasets (110). The outputs of each machine learning model in the set of machine learning models (138) may be a prediction as to which of the datasets in the first group of datasets (102) and the second group of datasets (110) match (e.g., to identify the source dataset (104) and the target dataset (112) as being related to each other).

Theoretically, the set of machine learning models (138) may be used to identify that the source image data structure (106) is related to the target dataset (112) with no further processing performed. However, the existing classification or matching machine learning models are not sufficiently accurate for some data science applications. In other words, the use of the set of machine learning models (138) alone generates an unacceptable number of false positive results (i.e., identifying that the source image data structure (106) and the target dataset (112) are related, when they are not), or false negative results (i.e., identifying that the source image data structure (106) and the target dataset (112) are not related, when they are).

However, the retraining method described with respect to FIG. 2 provides an enhanced machine learning model that addresses the unacceptable inaccuracies of the set of machine learning models (138). In other words, the retrained machine learning model described with respect to FIG. 2 more accurately identifies matches between individual datasets among the first group of datasets (102) and the second group of datasets (110), relative to the set of machine learning models (138). Thus, one or more embodiments may be characterized as an improvement to the computer as a tool for matching or classifying disparate datasets.

Training of the set of machine learning models (138) is described with respect to FIG. 1B and FIG. 2. Use of the set of machine learning models (138) during an inference stage of machine learning is described with respect to FIG. 3.

The server (130) also includes one or more encoding networks (140) and decoding networks (142). The encoding networks (140) and the decoding networks (142) are part of an encoder-decoder machine learning model architecture. The encoder-decoder architecture is used for machine learning tasks that transform input data into a different representation or domain. The encoder part of the network processes the input data (in this case, the source dataset (104)) and encodes it into a fixed-dimensional representation. The decoding networks (142) then decode the representation to generate the output. The representation may include additional data (e.g., the supplemental pixels (122)) or may be the augmented data structure (124). Use of the encoder-decoder machine learning model architecture (i.e., the encoding networks (140) and the decoding networks (142)) is shown and described with respect to FIG. 2 and FIG. 3.

In an embodiment, the encoding networks (140) may be one or more layers of a convolutional neural network (CNN). The decoding networks (142) may be one or more layers a recurrent neural network (RNN). However, the encoding networks (140) and the decoding networks (142) may include other layers or other types of machine learning models disposed before or after the layers of the CNN or the layers of the RNN.

In one or more embodiments, one or more CNNs are used as the building blocks within the encoder-decoder architecture, especially with respect to processing images, such as the source image data structure (106) or the target image data structure (114). The CNNs may be used as the encoder to extract features from the input data. The output of the CNN is then fed into the decoding networks (142) for further processing and generating the desired output (e.g., the enhanced image (126) or the reconstructed target image (128)). For example, in image captioning tasks, a CNN is used, at least in part, as the encoder to extract visual features from an image. In turn, and a recurrent neural network (RNN) may be used, at least in part, as the decoding networks (142) to generate a descriptive caption based on these features.

The encoding networks (140) and the set of decoding networks (142) together may form a multimodal machine learning model. The multimodal machine learning model may process both images and text. The multimodal machine learning model is trained by the method of FIG. 2 to process a first combination of source text and source images and a second combination of a target text and target images in order to determine whether the source text and the source images match or are related to the target text and the target images.

The system shown in FIG. 1A also may include one or more user devices (144). The user devices (144) may be considered remote or local. A remote user device is a device operated by a third-party (e.g., an end user of a chatbot) that does not control or operate the system of FIG. 1A. Similarly, the organization that controls the other elements of the system of FIG. 1A may not control or operate the remote user device. Thus, a remote user device may not be considered part of the system of FIG. 1A.

In contrast, a local user device is a device operated under the control of the organization that controls the other components of the system of FIG. 1A. Thus, a local user device may be considered part of the system of FIG. 1A.

In any case, the user devices (144) are computing systems (e.g., the computing system (500) shown in FIG. 5A) that communicate with the server (130). A request to compare the first group of datasets (102) with the second group of datasets (110) may be received via the user devices (144), or an automated process. In another embodiment, one or more of the user devices (144) may be operated by a computer technician that services the various components of the system shown in FIG. 1A.

Attention is turned to FIG. 1B, which shows the details of the training controller (136). The training controller (136) is a training algorithm, implemented as software or application specific hardware, that may be used to train one or more of the machine learning models, encoding networks, or decoding networks described with respect to the computing system of FIG. 1A.

In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some pre-determined amount, or until some other termination condition occurs. After training, the final adjusted model is applied to unknown data (i.e., data for which the actual result is not known) in order to make predictions.

Some machine learning models may be applied to vector data structures. A vector is a computer readable data structure. A vector may take the form of a matrix, an array, a graph, or some other data structure. However, a frequently used vector form is a one by an N matrix, where each cell of the matrix represents the value for one feature. As described above, a feature is a topic of data (e.g., a color of an object, the presence of a word or alphanumeric text, a physical measurement type, etc.). A value is a numerical or other recorded specification of the feature. For example, if the feature is the word “cat,” and the word “cat” is present in a corpus of text, then the value of the feature may be “1” (to indicate a presence of the feature in the corpus of text).

In one or more embodiments, some of the data in the data repository (100) of FIG. 1A may be stored in the form of one or more vectors. For example, the first group of datasets (102), the source dataset (104), the source image data structure (106), the source text (108), the second group of datasets (110), the target dataset (112), the target image data structure (114), the target text (116), the classes of data (118), the missing pixels (120), the supplemental pixels (122), the augmented data structure (124), the enhanced image (126), and the reconstructed target image (128) may be expressed as vectors.

Returning to the operation of the training controller (136), training starts with training data (176), which may be expressed in vector form. The training data (176) may be data for which the final result is known with certainty. If the prediction does not match the label, then the weights of the layers in the machine learning model (178) may be updated and the training process iterated.

More generally, the training data (176) is provided as input to the machine learning model (178), which may be the set of machine learning models (138), the encoding networks (140), or the decoding networks (142) of FIG. 1A. The machine learning model (178) may be characterized as a program that has adjustable parameters. The program is capable of learning and recognizing patterns to make predictions. The output of the machine learning model (178) may be changed by changing one or more parameters of the algorithm, such as the parameter (180) of the machine learning model (178). The parameter (180) may be one or more weights, the application of a sigmoid function, a hyperparameter, or possibly many different variations that may be used to adjust the output of the function of the machine learning model (178).

One or more initial values are set for the parameter (180). The machine learning model (178) is then executed on the training data (176). The result is an output (182), which is a prediction, a classification, a value, or some other output which the machine learning model (178) has been programmed to output.

The output (182) is provided to a convergence process (184). The convergence process (184) is programmed to achieve convergence during the training process. Convergence is a state of the training process, described below, in which a pre-determined end condition of training has been reached. The pre-determined end condition may vary based on the type of machine learning model (178) being used (supervised versus unsupervised machine learning), or may be pre-determined by a user (e.g., convergence occurs after a set number of training iterations, described below).

In the case of supervised machine learning, the convergence process (184) compares the output (182) to a known result (186). The known result (186) is stored in the form of labels for the training data (176). For example, the known result (186) for a particular entry in an output (182) vector of the machine learning model (178) may be a known value, and that known value is a label that is associated with the training data (176).

Continuing the example of supervised machine learning model training, a determination is made whether the output (182) matches the known result (186) to a pre-determined degree. The pre-determined degree may be an exact match, a match to within a pre-specified percentage, or some other metric for evaluating how closely the output (182) matches the known result (186). Convergence may occur when the known result (186) matches the output (182) to within a pre-specified percentage. When many predictions are involved convergence may occur when more than a threshold number of predictions correctly match the corresponding labels.

For example, the threshold may be 95%. In such a case, when the machine learning model (178) accuracy reaches 95% then convergence occurs.

In the case of unsupervised machine learning (e.g., one or more of the set of machine learning models (138) of FIG. 1A), the convergence process (184) may be compared to the output (182) or to a prior output (182) in order to determine a degree to which the current output (182) changed relative to the immediately prior output (182) or to the original output (182). Once the degree of change fails to satisfy the threshold degree of change, then the machine learning model may be considered to have achieved convergence. Alternatively, an unsupervised model may determine pseudo labels to be applied to the training data and then achieve convergence as described above for a supervised machine learning model. Other machine learning training processes exist, but the result of the training process may be convergence.

If convergence has not occurred (a “no” at the convergence process (184)), then a loss function (188) is generated. The loss function (188) is a program which adjusts the parameter (180) (one or more weights, settings, etc.) in order to generate an updated parameter (190). The basis for performing the adjustment is defined by the program that makes up the loss function (188). The program may be an algorithm which attempts to guess how the parameter (180) may be changed so that the next execution of the machine learning model (178), using the training data (176) with the updated parameter (190), will have an output (182) that is more likely to result in convergence. In this manner, the next execution of the machine learning model (178) is more likely to match the known result (186) (supervised learning), or which is more likely to result in an output (182) that more closely approximates the prior output (one unsupervised learning technique), or which otherwise is more likely to result in convergence.

In any case, the loss function (188) is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 1B may be multiple parameters, weights, settings, etc.

During deployment, the trained machine learning model (192) with the trained parameter (194) is executed again, but this time on unknown data (which may be in the form of an unknown data vector) for which the final result is not known. The output of the trained machine learning model (192) is then treated as a prediction of the information of interest relative to the unknown data.

While FIG. 1A and FIG. 1B show a configuration of components, other configurations may be used without departing from the scope of one or more embodiments. For example, various components may be combined to create a single component. As another example, the functionality performed by a single component may be performed by two or more components.

FIG. 2 and FIG. 3 show flowcharts of a method for training and using a pixelated encoder machine learning model for matching disparate data, in accordance with one or more embodiments. The methods of FIG. 2 and FIG. 3 may be implemented using the system of FIG. 1A or FIG. 1B, and one or more of the steps may be performed by or received at one or more computer processors.

Step 200 includes applying a set of machine learning models to a first group of datasets and a second group of datasets to identify a source dataset, in the first group of datasets, that matches a target dataset, in the second group of datasets. Applying the set of machine learning models may be performed by inputting some or all of the first group of datasets and the second group of datasets into the set of machine learning models. For example, the first group of datasets and the second group of datasets may be input into a combination of convolutional neural networks (in the case of images), large language models (in the case of text), or supervised or unsupervised classification models (in the case of either images or text). The input data may be input into multiple ones of the set of machine learning models.

Then, applying the set of machine learning models includes executing the set of machine learning models on the input. The output is a classification that one or more of the source dataset or the target dataset fall into a similar classification, or that the source dataset and the target dataset match. A match means that the source dataset and the target dataset equal each other, are associated with one another, or share a similar classification.

In an embodiment, step 200 may use one or more known matching models or algorithms to identify matching datasets among the first group of datasets and the second group of datasets. However, as indicated above, the set of machine learning models may not be deemed accurate enough for the uses to which the matched data will be put. The other steps of FIG. 2 may be used to train an improved machine learning model that improve the accuracy of the match to a predetermined degree that is greater than the accuracy of the set of machine learning models.

Step 202 includes receiving the source dataset as a source image data structure and receiving the target dataset as a target image data structure. The image data structures may be received from a remote repository or retrieved from a local repository. The image data structures may be received by receiving the images, or by constructing the images from text (e.g., using a CNN to build an image from text).

In an embodiment, text also may be included with the images. The text may be in addition to the images or describe the images. Images and text, together, may be processed by multimodal machine learning models, such as the multimodal convolutional layers of the encoding networks described with respect to step 204, below.

Step 204 includes applying a set of multimodal convolutional layers of encoding networks to the source image data structure and the target image data structure to generate classes of data present in at least one of the source image data structure and the target image data structure. The layers of the decoding networks may recognize types of data present in the images. For example, a bounding box next to pixels that form the text “account balance” may be classified as a class defined as “account balance.” The class “account balance” may have a value associated with the class (e.g., a number representing a value of the class “account balance.”)

The classes of data may be dynamically generated may be referred to as unsupervised classes of data. The classes are “unsupervised,” because the classes are not verified or labeled as being the classes assigned by the encoding networks.

Step 206 includes identifying, using the source image data structure and the target image data structure, missing pixels that are missing in at least one of the source image data structure and the target image data structure. The missing pixels may be identified by comparing the source image data structure to the target image data structure and noting pixels that are present in one dataset, but not the other. The pixels in one image data structure that are not present in the other image data structure may be identified as the missing pixels in the other dataset. For example, if the source image data structure includes a blank line where the target image data structure includes pixels, then the blank line in the source image data structure is deemed to have missing pixels.

Step 208 includes generating, from text present in at least one of the source dataset and the target dataset, supplemental pixels corresponding to the missing pixels. The supplemental pixels may be generated by identifying the words formed by the pixels in the image data structure that do not contain the missing pixels, or may be generated directly from source text in the source dataset. In either case, the pixels that form the text are deemed to be “supplemental pixels.” As in step 210 below, the supplemental pixels are added to the other image data structure.

For example, the target image data structure includes pixels that form text which has been associated with the missing pixels in the source data structure. Alternatively, or in addition, the target text relates to the missing pixels and is converted into pixels that are associated with the missing pixels in the source data structure. The resulting pixels are supplemental pixels.

Step 210 includes augmenting at least one of the source image data structure and the target image data structure with the supplemental pixels to generate at least one enhanced image. Augmenting may be accomplished by adding the pixels, or an embedded version of the pixels, to the other image data structure. For example, the supplemental pixels may be added to the source image data structure. Alternatively, an embedded version of the supplemental pixels (i.e., a vector) may be added to an embedded version of the source image data structure (i.e., another vector). A similar procedure may apply by augmenting missing pixels in the target image data structure with supplemental pixels derived from the source image data structure (106) or the source text (108).

In any case, the supplemental pixels are generated by a set of pixelated encoders (encoding layers). The supplemental pixels are then used to add missing information in the other image data structure output from the multimodal layers of the encoding networks.

Step 212 includes retraining, using an augmented data structure including the at least one enhanced image, the set of multimodal convolutional layers of the encoding networks and a set of decoding networks to generate a retrained model. The augmented data structure may include includes a combination of the at least one enhanced image, the classes of data, and the text. The retrained model is trained to determine whether the source dataset matches the target dataset. Retraining is performed by performing the training procedure described with respect to FIG. 1B. However, now, the machine learning model (178) of FIG. 1B is the set of encoding networks and the set of decoding networks, and the set of augmented data structures form the training data (176) of FIG. 1B.

Retraining the encoder-decoder networks changes the parameters of the encoder-decoder networks, thereby intrinsically changing the operation of the encoder-decoder networks. As a result, the accuracy of the encoder-decoder networks is improved with respect to classifying whether a source dataset matches a target dataset.

For example, the method of FIG. 2 may be extended to include classification steps. In particular, the method of FIG. 2 also may include receiving a new source dataset and a new target dataset. The new target and source datasets may or may not be part of the groups of datasets used to train the encoder-decoder networks.

Then, the retrained model is applied to the new source dataset and the new target dataset. The output of the retrained model is a determination whether the new source dataset matches the new target dataset.

If the new source dataset matches the new target dataset, then the method also may include classifying, after retraining, the new source dataset and the new target dataset based on the determination. For example, the target dataset may be classified as being related to the source dataset. In a specific example, the pay service transaction in the target dataset may be identified as being related to, or part of the same transaction, represented in a bank statement in the source dataset.

The method of FIG. 2 may be further extended. For example, the method may include generating, after retraining and based on classifying, new classes. The new classes may be the classes of data that generate a new set of classes of data. Then, retraining may be repeated using the new set of classes of data, the at least one enhanced image, and the text. Thus, the accuracy of the retrained encoder-decoder networks may be further improved.

Attention is now turned to FIG. 3. FIG. 3 may be characterized as a method of using the retrained encoder-decoder networks of FIG. 1, and thus may be characterized as a method of using a pixelated encoder machine learning model for matching disparate data.

Step 300 includes applying a set of machine learning models to a first group of datasets and a second group of datasets to identify a source dataset, in the first group of datasets, that matches a target dataset, in the second group of datasets. In an embodiment, the set of machine learning models include a set of regression machine learning models. Step 300 may be performed similarly to step 200 in FIG. 2. In an embodiment, the first group of datasets are stored in a first remote data repository and the second group of datasets are stored in a second remote data repository different than the first remote data repository.

Step 302 includes receiving the source dataset as a source image data structure and receiving the target dataset as a target image data structure. Step 302 may be performed in a manner similar to step 202 of FIG. 2.

Step 304 includes applying a set of multimodal convolutional layers of encoding networks to the source image data structure and the target image data structure to generate a vector including an encoded representation of the target image data structure and the source image data structure, and also classes of data present in at least one of the source image data structure and the target image data structure. The encoding networks and the set of decoding networks together include a multimodal machine learning model trained to process a first combination of source text and source images and a second combination of a target text and target images in order to determine whether the source text and the source images match or are related to the target text and the target images. Step 304 otherwise may be similar to step 204 of FIG. 2.

Step 306 includes identifying, using the source image data structure, the target image data structure, and the classes of data, missing pixels that are missing in at least one of the source image data structure and the target image data structure. Step 306 may be performed in a manner similar to step 206 of FIG. 2.

Step 308 includes generating, from text present in at least one of the source dataset and the target dataset, supplemental pixels corresponding to the missing pixels. Step 308 may be performed in a manner similar to step 208 of FIG. 2.

Step 310 includes applying the set of multimodal convolutional layers to the supplemental pixels to generate a supplemental vector. Applying the multimodal convolutional layers embeds the supplemental pixels in the vector format.

Step 312 includes augmenting the vector with the supplemental vector to generate an enhanced vector. Step 312 may be performed in a manner similar to step 210 of FIG. 2.

Step 314 includes applying a set of decoding networks to the enhanced vector to generate a reconstructed target image data structure. In other words, the decoding networks build or reconstruct the target image data structure from the enhanced vector, thereby generating a new image (i.e., the reconstructed target image data structure, which also may be characterized as an enhanced image data structure).

Step 316 includes comparing the target image data structure or the source image data structure to the reconstructed target image data structure to generate a difference. For example, the two image data structures may be compared, pixel by pixel, to determine which pixels are different with respect to a common coordinate system generated or used for the two image data structures. The differences between the pixels may be recorded as the difference between the two image data structures.

The determination of whether the target image data structure is compared to the reconstructed target image data structure, or the source image data structure is so compared, depends on which image contained the missing pixels. If the source image data structure included the missing pixels, then the source image data structure is the reconstructed image data structure. In this case, the reconstructed image data structure is compared to the target image data structure to see if the two match. However, if the target image data structure included the missing pixels, then the target image data structure is the reconstructed image data structure. In this case, the reconstructed image data structure is compared to the source image data structure to see if the two match.

Step 318 includes storing, in a non-transitory computer readable storage medium and responsive to the difference satisfying a threshold value, the target dataset as being related to the source dataset. For example, metadata may be associated with or added to the source dataset, the target dataset, or both, to indicate that the two datasets are related to each other. In another example, a spreadsheet or some other file may be used to store which datasets, among the first and second groups of data, are related to each other as source and target datasets.

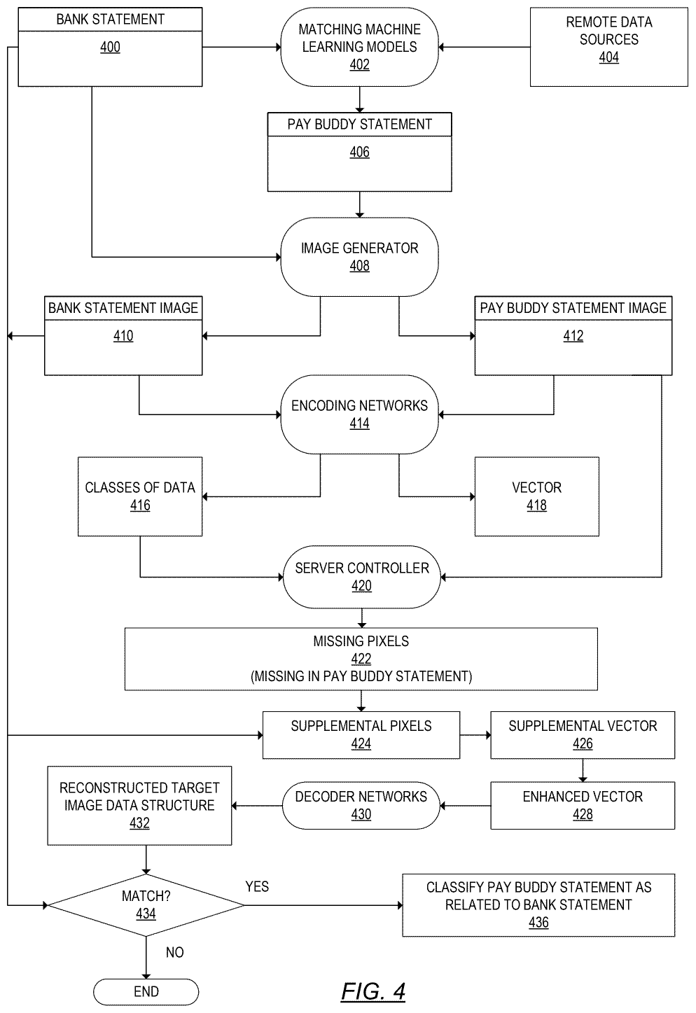

Once the source and target datasets are stored as being related, the association or relationship between the datasets may be used in additional procedures. For example, accounting software may record a bank statement (source dataset) as being related to an online pay service statement (target dataset), and the transactions therein related to each other accordingly. See FIG. 4 for a specific example in this regard. In another example of astronomical research, a first star in a source dataset may be classified as being compositionally related to a second star in another galaxy in a target dataset. Other examples are possible.

While the various steps in the above flowcharts are presented and described sequentially, at least some of the steps may be executed in different orders, may be combined or omitted, and at least some of the steps may be executed in parallel. Furthermore, the steps may be performed actively or passively.

FIG. 4 shows an example of using a pixelated encoder machine learning model for matching disparate data as part of an automated transaction categorization system, in accordance with one or more embodiments. The following example is for explanatory purposes only and not intended to limit the scope of one or more embodiments.

Initially, a bank statement (400) (i.e., a source dataset) is received and provided as input to a set of matching machine learning models that are trained to identify matching datasets contained in a first group of data (i.e., bank statements) and a second group of data (i.e., statements from an online payment source). A group of data contained in one or more remote data sources (404) also are provided as input to the set of matching machine learning models (402). Specifically, the group of data in the remote data sources (404) are statements from an online pay service known as “pay buddy.”

The output of the set of matching machine learning models (402) is a pay buddy statement (406). Thus, the set of matching machine learning models (402) classified the pay buddy statement (406) as being related to the bank statement (400).

Next, the bank statement (400) and the pay buddy statement (406) are provided as input to an image generator (408). The image generator (408) converts the bank statement (400) and any text associated with the bank statement (400) into a bank statement image (410). The image generator (408) also converts the pay buddy statement (406) and any text associated with the pay buddy statement (406) into a pay buddy statement image (412).

The bank statement image (410) and the pay buddy statement image (412) are provided as input to a number of encoding networks (414). The encoding networks (414) generate a number of classes of data (416) contained in the bank statement image (410) (and hence in the bank statement (400), in the pay buddy statement image (412), in the pay buddy statement (406), or both). In this example, the classes of data (416) are contained in the bank statement image (410).

The encoding networks (414) also output a vector (418). The vector is an embedded representation of the bank statement image (410), the pay buddy statement image (412), or both. The vector (418) may be two vectors, one for each of the bank statement image and the pay buddy statement image.

Next, the pay buddy statement image (412) and the classes of data (416) are provided to a server controller (420), which may include an image processing application. The server controller (420) identifies missing pixels (422) that are missing in the pay buddy statement image (412), but are present in the bank statement image (410).

Then, the server controller generates a number of supplemental pixels (424) from the bank statement image (410) that correspond to the missing pixels (422) in the pay buddy statement image (412). The supplemental pixels are encoded by the encoding networks (414) to generate a supplemental vector (426). The server controller (420) then adds the supplemental vector (426) to the vector (418) that represents the pay buddy statement image (412) to generate an enhanced vector (428). The enhanced vector (428) is an encoded representation of the pay buddy statement image (412) plus the supplemental pixels (424).

A number of decoder networks (430) are then applied to the enhanced vector (428). The output of the decoder networks (430) is a reconstructed target image data structure (432). In this example, the reconstructed target image data structure (432) is a reconstructed version of the pay buddy statement image (412) plus the supplemental pixels (424). In other words, the reconstructed target image data structure (432), when rendered, shows the pay buddy statement image (412) plus the text supplied from the bank statement image (410).

A determination is then made at step (434) whether the bank statement image (410) matches the reconstructed target image data structure (432). If so (a “yes” result at step (434)), then the pay buddy statement (406) is classified as being related to the bank statement (400). The classification may be stored as metadata attached to the bank statement (400), the pay buddy statement (406), or both, or may be stored in a spreadsheet or some other non-transitory computer readable storage medium for future use. The use may be, for example, to instruct accounting software to identify a transaction in the bank statement (400) as corresponding to another, related transaction in the pay buddy statement (406), and to proceed accordingly with respect to the accounting procedures performed by the accounting software.

However, if the bank statement image (410) does not match the reconstructed target image data structure (432) (a “no” result at step (434)), then the process terminates. No association is made between the bank statement (400) and the pay buddy statement (406).

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system (500), such as the computing system (500) shown in FIG. 5A, or a group of nodes combined may correspond to the computing system (500) shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system (500), such as the computing system (500) shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above may be devised which do not depart from the scope of the claims as disclosed herein. Accordingly, the scope should be limited only by the attached claims.

What is claimed is:

1. A method comprising:
applying a set of machine learning models to a first group of datasets and a second group of datasets to identify a source dataset, in the first group of datasets, that matches a target dataset, in the second group of datasets;
receiving the source dataset as a source image data structure and receiving the target dataset as a target image data structure;
applying a set of multimodal convolutional layers of a plurality of encoding networks to the source image data structure and the target image data structure to generate a plurality of classes of data present in at least one of the source image data structure and the target image data structure;
identifying, using the source image data structure and the target image data structure, a plurality of missing pixels that are missing in at least one of the source image data structure and the target image data structure;
generating, from text present in at least one of the source dataset and the target dataset, a plurality of supplemental pixels corresponding to the plurality of missing pixels;
augmenting at least one of the source image data structure and the target image data structure with the plurality of supplemental pixels to generate at least one enhanced image; and
retraining, using an augmented data structure comprising the at least one enhanced image, the set of multimodal convolutional layers of the plurality of encoding networks and a set of decoding networks to generate a retrained model.

2. The method of claim 1, wherein the augmented data structure comprises combination of the at least one enhanced image, the plurality of classes of data, and the text.

3. The method of claim 1, wherein the retrained model is trained to determine whether the source dataset matches the target dataset, and wherein the set of machine learning models comprise a set of text-based regression machine learning models.

4. The method of claim 1, further comprising:
receiving a new source dataset and a new target dataset; and
applying the retrained model to the new source dataset and the new target dataset to determine whether the new source dataset matches the new target dataset.

5. The method of claim 3,
wherein applying the retrained model results in a determination that the new source dataset matches the new target dataset, and
wherein the method further comprises classifying, after retraining, the new source dataset and the new target dataset based on the determination.

6. The method of claim 4, further comprising:
generating, after retraining and based on classifying, a plurality of new classes;
adding the plurality of new classes to the plurality of classes of data to generate a new set of classes of data; and
repeating retraining using the new set of classes of data, the at least one enhanced image, and the text.

7. The method of claim 1, wherein the plurality of encoding networks and the set of decoding networks together comprise a multimodal machine learning model trained to process a first combination of source text and source images and a second combination of a target text and target images in order to determine whether the source text and the source images matches or is related to the target text and the target images.

8. The method of claim 1, wherein the first group of datasets are stored in a first remote data repository and the second group of datasets are stored in a second remote data repository different than the first remote data repository.

9. A method comprising:
applying a set of machine learning models to a first group of datasets and a second group of datasets to identify a source dataset, in the first group of datasets, that matches a target dataset, in the second group of datasets;
receiving the source dataset as a source image data structure and receiving the target dataset as a target image data structure;
applying a set of multimodal convolutional layers of a plurality of encoding networks to the source image data structure and the target image data structure to generate a vector comprising an encoded representation of the target image data structure and the source image data structure, and also a plurality of classes of data present in at least one of the source image data structure and the target image data structure;
identifying, using the source image data structure, the target image data structure, and the plurality of classes of data, a plurality of missing pixels that are missing in at least one of the source image data structure and the target image data structure;
generating, from text present in at least one of the source dataset and the target dataset, a plurality of supplemental pixels corresponding to the plurality of missing pixels;
applying the set of multimodal convolutional layers to the plurality of supplemental pixels to generate a supplemental vector;
augmenting the vector with the supplemental vector to generate an enhanced vector;
applying a set of decoding networks to the enhanced vector to generate a reconstructed target image data structure;
comparing the target image data structure or the source image data structure to the reconstructed target image data structure to generate a difference; and
storing, in a non-transitory computer readable storage medium and responsive to the difference satisfying a threshold value, the target dataset as being related to the source dataset.

10. The method of claim 9, wherein the set of machine learning models comprise a set of regression machine learning models.

11. The method of claim 9, wherein the plurality of encoding networks and the set of decoding networks together comprise a multimodal machine learning model trained to process a first combination of source text and source images and a second combination of a target text and target images in order to determine whether the source text and the source images match or are related to the target text and the target images.

12. The method of claim 9, wherein the first group of datasets are stored in a first remote data repository and the second group of datasets are stored in a second remote data repository different than the first remote data repository.

13. A system comprising:
a computer processor;
a data repository in communication with the computer processor and storing:
a first group of datasets including a source dataset comprising a source image data structure,
a second group of datasets including a target dataset comprising a target image data structure,
text present in at least one of the source dataset and the target dataset,
a plurality of classes of data present in at least one of the source image data structure and the target image data structure,
a plurality of missing pixels that are missing in at least one of the source image data structure and the target image data structure,
a plurality of supplemental pixels corresponding to the plurality of missing pixels,
at least one enhanced image, and
an augmented data structure comprising a combination of the at least one enhanced image, the plurality of classes of data, and the text;
a set of machine learning models trained, when executed by the computer processor, to compare the first group of datasets and the second group of datasets to identify the source dataset and the target dataset;
a set of multimodal convolutional layers of a plurality of encoding networks trained, when executed by the computer processor, to generate the plurality of classes of data present in at least one of the source image data structure and the target image data structure;
a set of decoding networks programmed, when executed by the computer processor, to:
identify, using the source image data structure and the target image data structure, the plurality of missing pixels,
generate, from the text, the plurality of supplemental pixels,
augment at least one of the source image data structure and the target image data structure with the plurality of supplemental pixels to generate the at least one enhanced image; and
a training controller programmed, when executed by the computer processor and using the set of augmented data structures, to generate a retrained model by retraining the set of multimodal convolutional layers of the plurality of encoding networks and the set of decoding networks.

14. The system of claim 13, wherein:
the text is associated with both the source image data structure and the target image data structure, and
the set of machine learning models is trained to match the text to match the source dataset with the target dataset.

15. The system of claim 14, wherein the plurality of encoding networks is further programmed to convert the text into the source image data structure and the target image data structure prior to applying the set of decoding networks to the source image data structure and the target image data structure.

16. The system of claim 14, wherein:
the set of machine learning models is trained to match the source dataset with the target dataset by matching the source image data structure to the target image data structure.

17. The system of claim 13, wherein the set of machine learning models comprise a set of text-based regression machine learning models.

18. The system of claim 13, wherein the plurality of encoding networks and the set of decoding networks together comprise a multimodal machine learning model trained to process a first combination of source text and source images and a second combination of a target text and target images in order to determine whether the source text and the source images match or are related to the target text and the target images.

19. The system of claim 13, wherein the first group of datasets are stored in a first remote data repository and the second group of datasets are stored in a second remote data repository different than the first remote data repository.

20. The system of claim 13, further comprising:
a server controller programmed, when executed by the computer processor, to:
receive a new source dataset and a new target dataset;
apply the retrained model to the new source dataset and the new target dataset to determine whether the new source dataset matches the new target dataset, wherein a determination is generated; and
classify, after retraining, the new source dataset and the new target dataset based on the determination.
